(19) United States
(12) Patent Application Publication
(10) Pub. No.: US 2011/0130043 A1
(43) Pub. Date: Jun. 2, 2011

(54) COMBINATION OF SOCKET AND PLUG FOR BATTERY CONNECTOR

(76) Inventor: Wan-Tien CHEN, Taipei (TW)

(21) Appl. No.: 12/626,776

(22) Filed: Nov. 27, 2009

(51) Int. Cl. H01R 24/00

(52) U.S. Cl. 439/660

(57) ABSTRACT

The present invention relates to a combination of socket and plug for battery connector, comprises a plug having an insulation housing and a plurality of first conduction terminals, wherein a front end of the insulation housing is installed with a concave slot, two ends of the concave slot are installed with a plurality of first terminal channels for receiving the first conduction terminals; and a socket having an insulation housing and a plurality of second conduction terminals, wherein a front end of the insulation housing is installed with a convex sheet for being inserted in the concave slot, two ends of the convex sheet are installed with a plurality of second terminal channels for receiving the second conduction terminals, and the first conduction terminals are received in the second conduction terminals and are in contact with the second conduction terminals.

### BACKGROUND OF THE INVENTION

1. Field of the Invention

The present invention relates to a combination of socket and plug, more particularly to a combination of socket and plug for a battery connector.

2. Description of Related Art

A portable electronic device, e.g. a notebook computer, often uses a rechargeable battery as its power source, a substrate of the portable electronic device is installed with a socket or a plug while the rechargeable battery is installed with a plug or a socket; with the combination of socket/plug or plug/socket, not only the rechargeable battery can be recharged but also power can be supplied to the portable electronic device by the rechargeable battery.

A conventional battery connector, for example the battery receptacle connector disclosed in the U.S. Pat. No. 6,171,126 comprises an insulation housing substantially in an elongated shape and a plurality of terminals received in the insulation housing, the inside of the insulation housing is installed with a plurality of terminal channels that are aligned in parallel, and each of the terminal channels has plural interfere slots and the top and front surfaces of the insulation housing are formed with openings. The terminal mainly consists of a base portion, a welding end portion, a first positioning portion, a second positioning portion, an arm portion, a first insertion portion and a second insertion portion; by installing the first insertion portion and the second insertion portion, the connector is able to be inserted in multi directions, and the first positioning portion and the second positioning portion are provided for limiting the terminals inside the insulation housing in multi orientations, so the terminals are prevented from shifting or loosening during operation. But the terminals disclosed in this patent have welding end portions, first insertion portions and second insertion portions, the structure thereof is complicated and production cost is therefore raised.

A conventional combination of socket and plug for battery connector, for example the electrical connector with ground contacts disclosed in the U.S. Pat. No. 7,422,451 comprises a header and a socket, the socket and the header are respectively installed with ground contacts for providing a ground function, the socket is provided with plural socket contacts, each of the socket contacts has a retention, a pair of resilient arms and a leg. Not only the socket and header are respectively installed with ground contacts, the structure of the socket contacts is relatively complicated therefore production cost is raised.

For improving the mentioned disadvantages of the conventional battery connector and the combination of socket and plug for battery connector, the present invention provides a combination of socket and plug for battery connector.

### SUMMARY OF THE INVENTION

One object of the present invention is to provide a combination of socket and plug for battery connector, wherein the socket is installed with a concave slot while the plug is installed with a convex sheet, so the socket and the plug are more easily to be combined and fastened.

Another object of the present invention is to provide a combination of socket and plug for battery connector, wherein the plug is installed with a plurality of first conduction terminals, each of the first conduction terminals is simple in structure for lowering production cost.

One another object of the present invention is to provide a combination of socket and plug for battery connector, wherein the socket is installed with a plurality of second conduction terminals, each of the second conduction terminals is simple in structure for lowering production cost.

For achieving the objects mentioned above, one solution provided by the present invention is to provide a plug for battery connector, comprises an insulation housing, a front end thereof is installed with a convex sheet, two ends of the convex sheet are installed with a plurality of terminal channels, and at least one end of the insulation housing is installed with a housing slot; a plurality of conduction terminals respectively received in the terminal channels, and each of the conduction terminals has a main body, a rear end of the main body is outwardly extended with a fastening portion; and at least one lock sheet received in the insulation housing for fastening the insulation housing on a substrate.

For achieving the objects mentioned above, another solution provided by the present invention is to provide a socket for battery connector, comprises an insulation housing, a front end thereof is installed with a concave slot, two ends of the concave slot are installed with a plurality of terminal channels; and a plurality of conduction terminals respectively received in the terminal channels, and each of the conduction terminals has two main bodies, a connection portion is defined between the two main bodies, a fastening portion is downwardly extended from the connection portion, an arm portion is respectively extended from front ends of the two main bodies, each of the arm portions is in a tapering status and is installed with a contact portion after the front end thereof is inwardly bended.

For achieving the objects mentioned above, one another solution provided by the present invention is to provide a combination of socket and plug for battery connector, comprises a plug having an insulation housing and a plurality of first conduction terminals, wherein a front end of the insulation housing is installed with a concave slot, two ends of the concave slot are installed with a plurality of first terminal channels for receiving the first conduction terminals; and a socket having an insulation housing and a plurality of second conduction terminals, wherein a front end of the insulation housing is installed with a convex sheet for being inserted in the concave slot, two ends of the convex sheet are installed with a plurality of second terminal channels for receiving the second conduction terminals, and the first conduction terminals are received in the second conduction terminals and are in contact with the second conduction terminals.

### BRIEF DESCRIPTION OF THE DRAWINGS

FIG. 1 is a schematic front exploded view of the plug for battery connector of one preferred embodiment of the present invention;

FIG. 2 is a schematic rear exploded view of the plug for battery connector of one preferred embodiment of the present invention;

FIG. 3a is a schematic front view of the assembly of the plug for battery connector of one preferred embodiment of the present invention;

FIG. 3b is a schematic rear view of the assembly of the plug for battery connector of one preferred embodiment of the present invention;

FIG. 4 is a schematic front exploded view of the socket for battery connector of one preferred embodiment of the present invention;

FIG. 5 is a schematic rear exploded view of the socket for battery connector of one preferred embodiment of the present invention;

FIG. 6a is a schematic front view of the assembly of the socket for battery connector of one preferred embodiment of the present invention;

FIG. 6b is a schematic rear view of the assembly of the socket for battery connector of one preferred embodiment of the present invention;

FIG. 7 is a schematic cross sectional view of the combination of the plug and the socket for battery connector of one preferred embodiment of the present invention.

### DETAILED DESCRIPTION OF THE PREFERRED EMBODIMENT

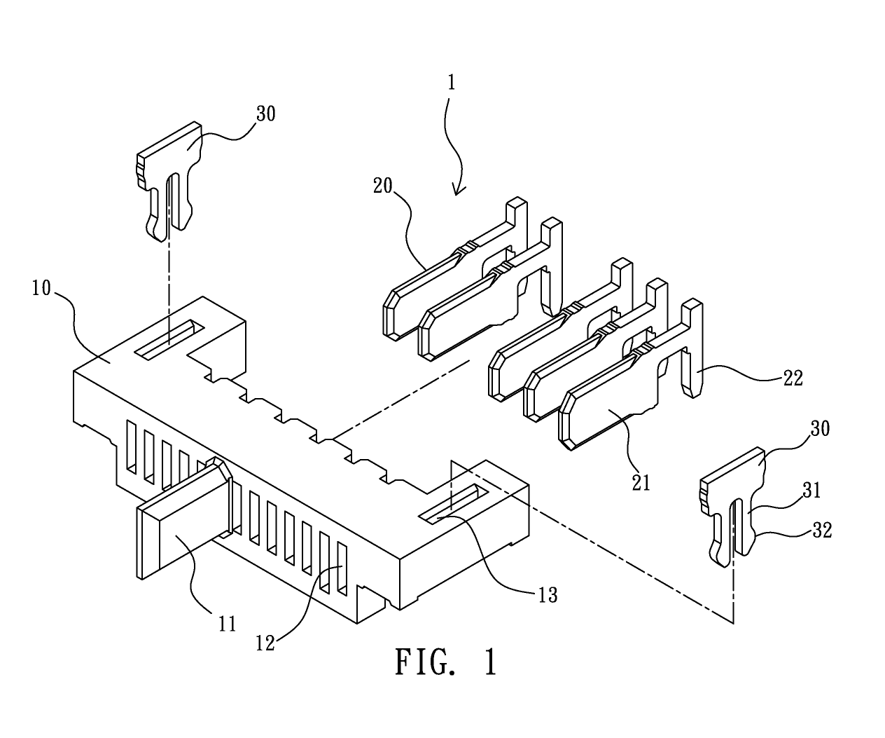

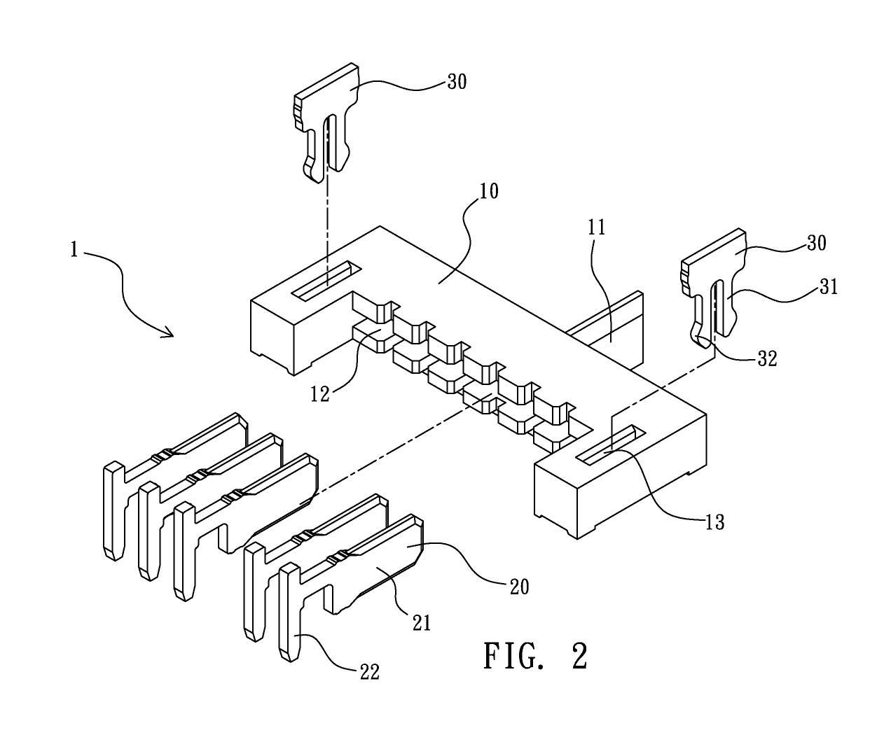

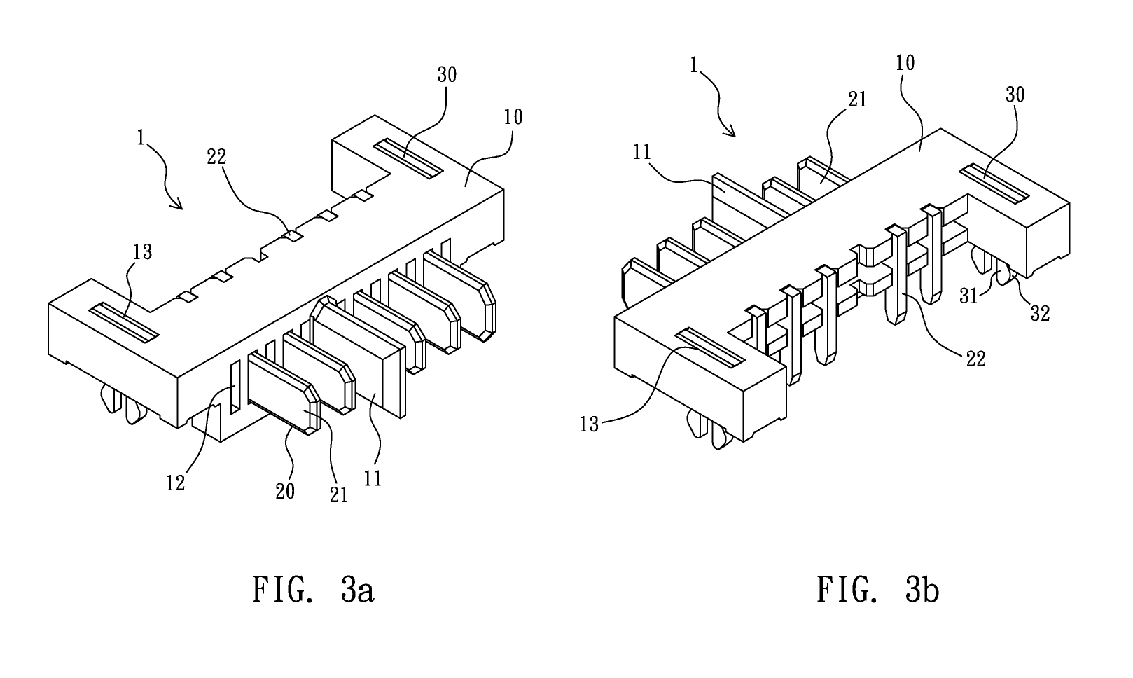

Referring from FIG. 1 to FIG. 3b, wherein FIG. 1 is a schematic front exploded view of the plug for battery connector of one preferred embodiment of the present invention; FIG. 2 is a schematic rear exploded view of the plug for battery connector of one preferred embodiment of the present invention; FIG. 3a is a schematic front view of the assembly of the plug for battery connector of one preferred embodiment of the present invention; FIG. 3b is a schematic rear view of the assembly of the plug for battery connector of one preferred embodiment of the present invention.

As shown in figures, the plug 1 for battery connector provided by the present invention, which is suitable to be used in a battery of a portable electronic device or used on a substrate of a portable electronic device, e.g. but not limited to a notebook computer or a micro notebook, comprises: an insulation housing 10; a plurality of first conduction terminals 20; and at least one lock sheet 30.

The insulation housing 10 is made of insulation material, e.g. but not limited to plastic, and a front end thereof is installed with a convex sheet 11 which is installed with a plurality of first terminal channels 12 at its two ends, at least one end of the insulation housing 10 is installed with a housing slot 13. In this embodiment, for illustration, two ends of the insulation housing 10 are respectively provided with a housing slot 13.

The first conduction terminals 20 are made of metal material, and are respectively received in the first terminal channels 12, and each of the first conduction terminals 20 has a main body 21 having a fastening portion 22 outwardly extending from its rear end, and the fastening portion 22 is longitudinally bended after extending from the rear end of the main body 21 for being inserted and fastened on a substrate (not shown).

The lock sheet 30 is installed in the housing slot 13 so as to fasten the insulation housing 10 on the substrate. The lock sheet 30 is made of metal material and is further installed with two free ends 31, a gap is defined between the two free ends 31, and a distal end of each of the free ends 31 has a protruding portion 32; when subject to an external force, the free ends 31 are inwardly bended so as to be received in the corresponding housing slot 13, when the external force is released, the free ends 31 are outwardly bounced so that the lock sheet 30 is fastened in the housing slot 13.

As shown in FIG. 3a and FIG. 3b, when being assembled, each of the first conduction terminals 20 is respectively received and fastened in the corresponding first terminal channels 12; then the lock sheets 30 are installed in the housing slots 13, so the assembly of the plug 1 provided by the present invention is obtained.

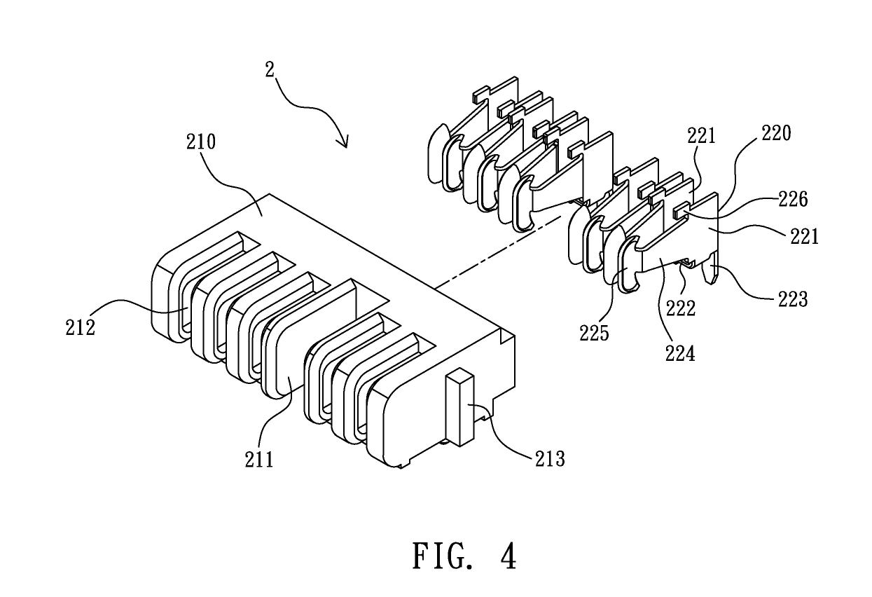

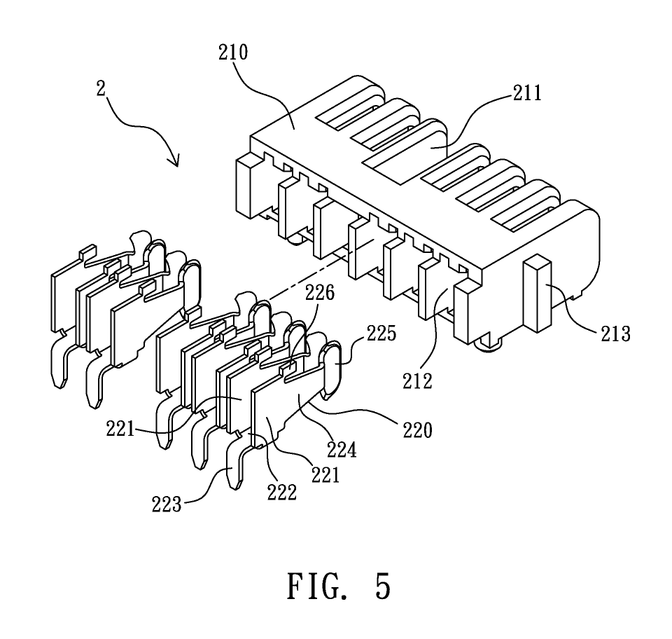

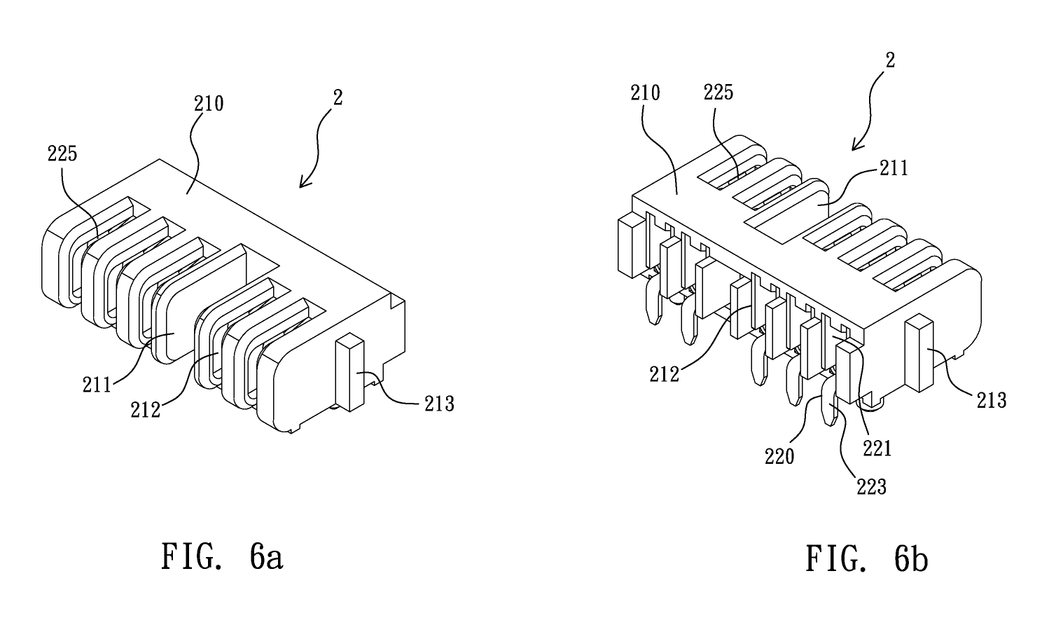

Referring from FIG. 4 to FIG. 6b, wherein FIG. 4 is a schematic front exploded view of the socket for battery connector of one preferred embodiment of the present invention; FIG. 5 is a schematic rear exploded view of the socket for battery connector of one preferred embodiment of the present invention; FIG. 6a is a schematic front view of the assembly of the socket for battery connector of one preferred embodiment of the present invention; FIG. 6b is a schematic rear view of the assembly of the socket for battery connector of one preferred embodiment of the present invention.

As shown in figures, the socket 2 for battery connector provided by the present invention, which is suitable to be used in a battery of a portable electronic device or on a substrate of a portable electronic device, e.g. but not limited to a notebook computer or a micro notebook, comprises: an insulation housing 210; and a plurality of second conduction terminals 220.

The insulation housing 210 is made of insulation material, e.g. but not limited to plastic, and a front end thereof is installed with a concave slot 211 for accommodating the convex sheet 11, two ends of the concave slot 211 are installed with a plurality of second terminal channels 212, and at least one end of the insulation housing 210 is installed with a latching portion 213. In this embodiment, for illustration, two ends of the insulation housing 210 are respectively installed with a latching portion 213.

The second conduction terminals 220 are made of metal material, and are respectively received in the second terminal channels 212, each of the second conduction terminals 220 has two main bodies 221, a connection portion 222 is defined between the two main bodies 221, a fastening portion 223 is downwardly extended from the connection portion 222, a front end of each of the two main bodies 221 are respectively extended with an arm portion 224, each of the arm portions 224 is e.g. in a tapering status and a contact portion 225 is installed to the arm portion 224 after the front end of the arm portion 224 is inwardly bended, for accommodating the main bodies 21 of the first conduction terminals 20, and an electrical connection is formed between the main body 21 and the contact portion 225. And each of the contact portions 225 is longitudinally extended from the top and the bottom ends of the distal end of the arm portion 224.

The main bodies 221 are further installed with a convex portion 226 so as to position the second conduction terminals 220 in the second terminal channels 212.

As shown in FIG. 6a and FIG. 6b, when being assembled, each of the second conduction terminals 220 is respectively received and fastened in the corresponding second terminal channels 212, so the assembly of the socket 2 for battery connector provided by the present invention is finished.

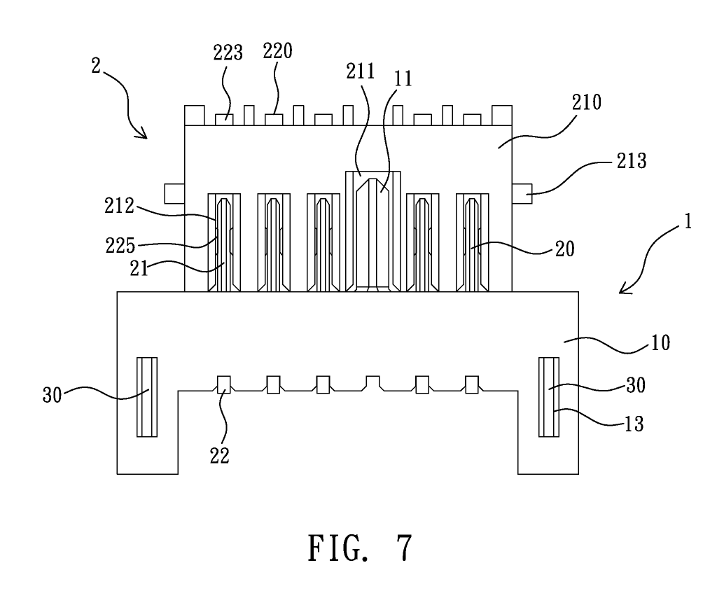

Referring to FIG. 7, which is a schematic cross sectional view of the combination of the plug and the socket for battery connector of one preferred embodiment of the present invention.

As shown in FIG. 7, when in use, the plug 1 for battery connector provided by the present invention is fastened on a substrate, the socket 2 for battery connector is fastened with a battery (not shown), or vice versa. When being assembled, the concave slot 211 installed in the front end of the socket 2 is aligned with the convex sheet 11 of the plug 1, so each of the second terminal channels 212 is aligned to each of the first conduction terminals 20, then an external force is applied to combine the socket 2 and the plug 1, so that the contact portion 225 of each of the second conduction terminals 220 is engaged with the main body 21 of each of the first conduction terminals 20, the electrical connection between the plug 1 and the socket 2 for battery connector provided by the present invention is therefore achieved. Thus the combination of the plug and socket for battery connector provided by the present invention is novel, comparing to a combination of a plug and socket for battery connector of conventional arts.

According to what is disclosed above, with the combination of the plug and socket for battery connector provided by the present invention, wherein the socket is installed with a concave lost while the plug is installed with a convex sheet, so the socket and the plug are more easily to be combined and fastened; and the plug is installed with a plurality of first conduction terminals, each of the first conduction terminals is simple in structure so the production cost thereof is reduced. Thus the present invention is novel, comparing to a combination of a plug and socket for battery connector of conventional arts.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A plug for battery connector, comprising:
an insulation housing, a front end thereof being installed with a convex sheet, two ends of said insulation housing being installed with a plurality of terminal channels, and at least one end of said insulation housing being installed with a housing slot, the plurality of terminal channels extending through the insulation housing from the front end thereof to a back end thereof, the housing slot extending through the insulation housing from a top thereof to a bottom thereof, the plurality of terminal channels extending through the insulation housing in a direction perpendicular to a direction of the housing slot;
a plurality of conduction terminals respectively received in said terminal channels, and each of said conduction terminals having a main body, a rear end of said main body being outwardly extended with a fastening portion; and
at least a lock sheet received in a housing slot for fastening said insulation housing on a substrate.

2. The plug for battery connector as claimed in claim 1, wherein said insulation housing is made of plastic material, said conduction terminals and said lock sheet are made of metal material.

3. The plug for battery connector as claimed in claim 1, wherein two ends of said insulation housing are respectively installed with said housing slot.

4. The plug for battery connector as claimed in claim 1, wherein said fastening portion is longitudinally bended after extending from said main body.

5. The plug for battery connector as claimed in claim 1, wherein said lock sheet is further installed with two free ends, each distal end of said free ends is installed with a protruding portion.

6. A socket for battery connector, comprising:
an insulation housing, a front end thereof being installed with a concave slot, two ends of said insulation housing being installed with a plurality of terminal channels, the plurality of terminal channels extending through the insulation housing from the front end thereof to a back end thereof; and
a plurality of conduction terminals respectively received in said terminal channels, and each of said conduction terminals having two main bodies, a connection portion being defined between said two main bodies, a fastening portion being downwardly extended from said connection portion, an arm portion being respectively extended from front ends of said two main bodies, each of said arm portions being in a tapering status and installed with a contact portion after the front end thereof being inwardly bended.

7. The socket for battery connector as claimed in claim 6, wherein said insulation housing is made of plastic material, said conduction terminals are made of metal material.

8. The socket for battery connector as claimed in claim 6, wherein two ends of said insulation housing are respectively installed with a latching portion.

9. The socket for battery connector as claimed in claim 6, wherein said contact portion is longitudinally extended from the distal end of said arm portion.

10. The socket for battery connector as claimed in claim 6, wherein each main body of said two main bodies of the plurality of conduction terminals has a convex portion protruding outwardly from a top thereof for positioning.

11. A combination of socket and plug for battery connector, comprising:
a plug having an insulation plug housing and a plurality of first conduction terminals, wherein a front end of said insulation plug housing being installed with a convex sheet, two ends of said insulation plug housing being installed with a plurality of first terminal channels for receiving said first conduction terminals, the plurality of first terminal channels extending through the insulation plug housing from a front end thereof to a back end thereof; and
a socket having an insulation socket housing and a plurality of second conduction terminals, wherein a front end of said insulation socket housing being installed with a concave slot, the concave slot being inserted in said convex sheet, two ends of the insulation socket housing being installed with a plurality of second terminal channels for receiving said second conduction terminals, the plurality of second terminal channels extending through the insulation socket housing from the front end thereof to a back end thereof, and said first conduction terminals being received in said second conduction terminals and in contact with said second conduction terminals.

12. The combination of socket and plug for battery connector as claimed in claim 11, wherein two ends of said plug are respectively installed with a housing slot, the housing slot extending through the insulation plug housing from a top thereof to a bottom thereof, the plurality of first terminal channels extending through the insulation plug housing in a direction perpendicular to a direction of the housing slot.

13. The combination of socket and plug for battery connector as claimed in claim 12, wherein said plug is further installed with two lock sheets respectively received in said housing slots, and each of said lock sheets has two free ends, a distal end of each of said free ends is installed with a protruding portion.

14. The combination of socket and plug for battery connector as claimed in claim 11, wherein each of said first conduction terminals is installed with a main body, a rear end of said main body is outwardly extended with a fastening portion, and said fastening portion is longitudinally bended after extending from said main body.

15. The combination of socket and plug for battery connector as claimed in claim 11, wherein each of said second conduction terminals is installed with two main bodies, a connection portion is defined between said two main bodies, a fastening portion is downwardly extended from said connection portion, an arm portion is respectively extended from front ends of said two main bodies, each of said arm portions is in a tapering status and installed with a contact portion after a front end thereof being inwardly bended.

16. The combination of socket and plug for battery connector as claimed in claim 15, wherein said contact portion is longitudinally extended from the distal end of said arm portion.

17. The combination of socket and plug for battery connector as claimed in claim 15, wherein each main body of said two main bodies of the plurality of second conduction terminals has a convex portion protruding outwardly from a top thereof for positioning.
